(19) United States
(12) Patent Application Publication
(10) Pub. No.: US 2013/0278668 A1
(43) Pub. Date: Oct. 24, 2013

(54) INK JET RECORDING METHOD AND INK JET RECORDING APPARATUS

(71) Applicant: SEIKO EPSON CORPORATION, Tokyo (JP)

(72) Inventor: Satoru MIYAMOTO, Matsumoto (JP)

(73) Assignee: Seiko Epson Corporation, Tokyo (JP)

(21) Appl. No.: 13/862,688

(22) Filed: Apr. 15, 2013

(30) Foreign Application Priority Data
Apr. 20, 2012 (JP) 2012-096329

(51) Int. Cl. B41J 29/377

(52) U.S. Cl. CPC B41J 29/377
USPC 347/17

(57) ABSTRACT

An ink jet recording method including a supporting portion that supports a work, a discharge head that discharges functional liquid, a heating portion that heats the functional liquid, and a cooling portion that cools the supporting portion, includes heating the functional liquid by using the heating portion such that a temperature of the functional liquid in the discharge head is a first temperature, and cooling the supporting portion by using the cooling portion. In the ink jet recording method, when a temperature of the work after the functional liquid discharged from the discharge head has landed onto the work is set to a second temperature and a temperature of a work supporting surface of the supporting portion during the cooling is set to a third temperature, the first temperature is equal to or higher than the second temperature and the second temperature is higher than the third temperature.

### CROSS-REFERENCE TO RELATED APPLICATIONS

The entire disclosure of Japanese Patent Application No. 2012-096329, filed Apr. 20, 2012 is expressly incorporated by reference herein.

### BACKGROUND

1. Technical Field

The present invention relates to an ink jet recording method and an ink jet recording apparatus.

2. Related Art

As an existing ink jet recording method that discharges photo-curable ink onto a recording target medium from a head, for example, known is a method of discharging the photo-curable ink in a state where a head temperature is set to be higher than a melting point of a cross-linking agent contained in the photo-curable ink and the melting point of the cross-linking agent contained in the photo-curable ink is set to be higher than a temperature of the recording target medium (for example, see JP-A-2012-16922).

When the photo-curable ink is discharged onto the recording target medium from the head as in the above-mentioned method, the photo-curable ink is heated in some cases. This makes it possible to keep the viscosity of the photo-curable ink constant and ensure stable discharge property. In this case, radiation heat generated by heating the photo-curable ink, reaction heat of the photo-curable ink, and the like, are transferred to the recording target medium, for example. Then, the heat transferred onto the recording target medium is transferred to a supporting portion such as a platen and is accumulated on the supporting portion gradually. As a result, the following problem arises. That is, the temperature of the recording target medium is increased and cannot be kept constant. Therefore, the bleeding when the photo-curable ink lands onto the recording target medium is not stable, resulting in lowering of image quality.

### SUMMARY

An advantage of some aspects of the invention is to solve at least a part of the issues mentioned above and can be realized in the following modes or as the following Application Examples.

An ink jet recording method according to the Application Example in an ink jet recording apparatus including a supporting portion that supports a work, a discharge head that discharges functional liquid onto the work supported by a work supporting surface of the supporting portion, a heating portion that heats the functional liquid, and a cooling portion that cools the supporting portion, includes heating the functional liquid by using the heating portion such that a temperature of the functional liquid in the discharge head is a first temperature, and cooling the supporting portion by using the cooling portion. In the ink jet recording method, when a temperature of the work after the functional liquid discharged from the discharge head has landed onto the work is set to a second temperature and a temperature of the work supporting surface during the cooling is set to a third temperature, the first temperature is equal to or higher than the second temperature and the second temperature is higher than the third temperature.

In the ink jet recording method according to the above-mentioned Application Example, it is preferable that the supporting portion be a supporting drum having a drum shape and the work be transported while being wound over the supporting drum, the second temperature be a temperature immediately after the work wound over the supporting drum has been separated from the supporting drum, the third temperature be a temperature measured at a position on the supporting surface over which the work is not wound, and the supporting drum be cooled such that the first temperature is equal to or higher than the second temperature and the second temperature is higher than the third temperature at the cooling.

In the ink jet recording method according to the above-mentioned Application Example, it is preferable that the functional liquid be photo-curable ink and a light irradiation device arranged on a transportation path of the work at the downstream side with respect to the discharge head so as to be opposed to the supporting surface be provided, the method further including irradiating the photo-curable ink landed onto the work with light from the light irradiation device.

In the ink jet recording method according to the above-mentioned Application Example, it is preferable that the cooling portion be a cooling fan and cool air be made to hit the supporting drum at the downstream side with respect to a rotating shaft of the supporting drum at the cooling.

An ink jet recording apparatus according to the Application Example includes a supporting portion that supports a work, a discharge head that discharges functional liquid onto the work supported by a work supporting surface of the supporting portion, a heating portion that heats the functional liquid, a cooling portion that cools the supporting portion, and a temperature adjusting portion that adjusts a first temperature to be equal to or higher than a second temperature and adjusts the second temperature to be higher than a third temperature when a temperature of the functional liquid in the discharge head is set to the first temperature, a temperature of the work after the functional liquid discharged from the discharge head has landed onto the work is set to the second temperature, and a temperature of the work supporting surface during the cooling is set to the third temperature.

The ink jet recording apparatus according to the above-mentioned Application Example further includes a first temperature acquiring portion that acquires the first temperature, a second temperature acquiring portion that acquires the second temperature, and a third temperature acquiring portion that acquires the third temperature. In the ink jet recording apparatus, the second temperature acquiring portion is arranged so as to measure the temperature of the work immediately after the work wound over the supporting drum has been separated from the supporting drum, the third temperature acquiring portion is arranged so as to measure the temperature of the supporting surface at a position on the supporting surface over which the work is not wound, and the temperature adjusting portion controls the heating portion such that the first temperature is a predetermined temperature and controls the cooling portion such that the first temperature is equal to or higher than the second temperature and the second temperature is higher than the third temperature.

The ink jet recording method according to the above-mentioned Application Example is an ink jet recording method of discharging the functional liquid onto the work supported by the supporting portion. In the ink jet recording method, the first temperature of the functional liquid to be discharged is adjusted to be equal to or higher than the second temperature of the work and the second temperature of the work is adjusted to be higher than the third temperature.

With this configuration, when the functional liquid is applied onto the work, the work receives radiation heat generated by heating the functional liquid, reaction heat of the functional liquid itself, and the like, in some cases. The third temperature of the supporting portion is adjusted to be lower than the second temperature of the work, so that the heat received by the work is transferred to the supporting portion to be dissipated. Accordingly, increase in the temperature of the work is suppressed so as to keep the temperature of the work substantially constant. Therefore, the bleeding when the functional liquid lands onto the work is stable, thereby forming an image with high quality.

In the ink jet recording method according to the above-mentioned Application Example, the supporting portion is cooled so as to adjust the third temperature of the supporting portion.

With this configuration, the supporting portion is cooled, so that the heat received by the work can be dissipated from the supporting portion efficiently.

The ink jet recording apparatus according to the above-mentioned Application Example is an ink jet recording apparatus that discharges the functional liquid onto the work supported by the supporting portion. The ink jet recording apparatus includes the temperature adjusting portion that adjusts the first temperature of the functional liquid to be equal to or higher than the second temperature of the work and the second temperature of the work to be higher than the third temperature of the supporting portion.

With this configuration, when the functional liquid is applied onto the work, the work receives radiation heat generated by heating the functional liquid, reaction heat of the functional liquid itself, and the like, in some cases. The third temperature of the supporting portion is adjusted to be lower than the second temperature of the work, so that the heat received by the work is transferred to the supporting portion to be dissipated. Accordingly, increase in the temperature of the work is suppressed so as to keep the temperature of the work substantially constant. Therefore, the bleeding when the functional liquid lands onto the work is stable, thereby forming an image with high quality.

The ink jet recording apparatus according to the above-mentioned Application Example includes the discharge head that discharges the functional liquid as liquid droplets onto the work supported by the supporting portion and the temperature adjusting portion includes the heating portion that heats the functional liquid in the discharge head, the first temperature acquiring portion that acquires the first temperature of the functional liquid, the second temperature acquiring portion that acquires the second temperature of the work, the cooling portion that cools the supporting portion, the third temperature acquiring portion that acquires the third temperature of the supporting portion, and the controller that controls the cooling portion based on the first temperature, the second temperature and the third temperature which have been acquired.

With this configuration, the functional liquid in the discharge head is controlled to be heated by driving of the heating portion. Therefore, the viscosity of the functional liquid becomes constant, thereby improving the discharge property. On the other hand, the first temperature data of the functional liquid in the discharge head is acquired by the first temperature acquiring portion. Further, the second temperature data of the work is acquired by the second temperature acquiring portion and the third temperature data of the supporting portion is acquired by the third temperature acquiring portion. The cooling portion is controlled based on the first to third temperatures which have been acquired. This makes it possible to dissipate heat from the supporting portion efficiently.

### BRIEF DESCRIPTION OF THE DRAWINGS

The invention will be described with reference to the accompanying drawings, wherein like numbers reference like elements.

FIG. 1 is a schematic view illustrating a configuration of an ink jet recording apparatus.

FIG. 2 is a schematic view illustrating a partial configuration of the ink jet recording apparatus.

FIG. 3 is a block diagram illustrating a control configuration of the ink jet recording apparatus.

### DESCRIPTION OF EXEMPLARY EMBODIMENTS

Hereinafter, an embodiment of the invention is described with reference to the drawings. It is to be noted that in the drawings, scales of layers and members are made different from actual scales thereof for making the layers and the members have sizes that can be recognized.

An ink jet recording method according to the embodiment is an ink jet recording method of discharging functional liquid onto a work supported by a supporting portion. In the ink jet recording method, a first temperature of the functional liquid to be discharged is adjusted to be equal to or higher than a second temperature of the work and the second temperature of the work is adjusted to be higher than a third temperature of the supporting portion. Furthermore, an ink jet recording apparatus according to the embodiment is an ink jet recording apparatus that discharges the functional liquid onto the work supported by the supporting portion. The ink jet recording apparatus includes a temperature adjusting portion that adjusts the first temperature of the functional liquid to be equal to or higher than the second temperature of the work and adjusts the second temperature of the work to be higher than the third temperature of the supporting portion. Hereinafter, detail description thereof is made.

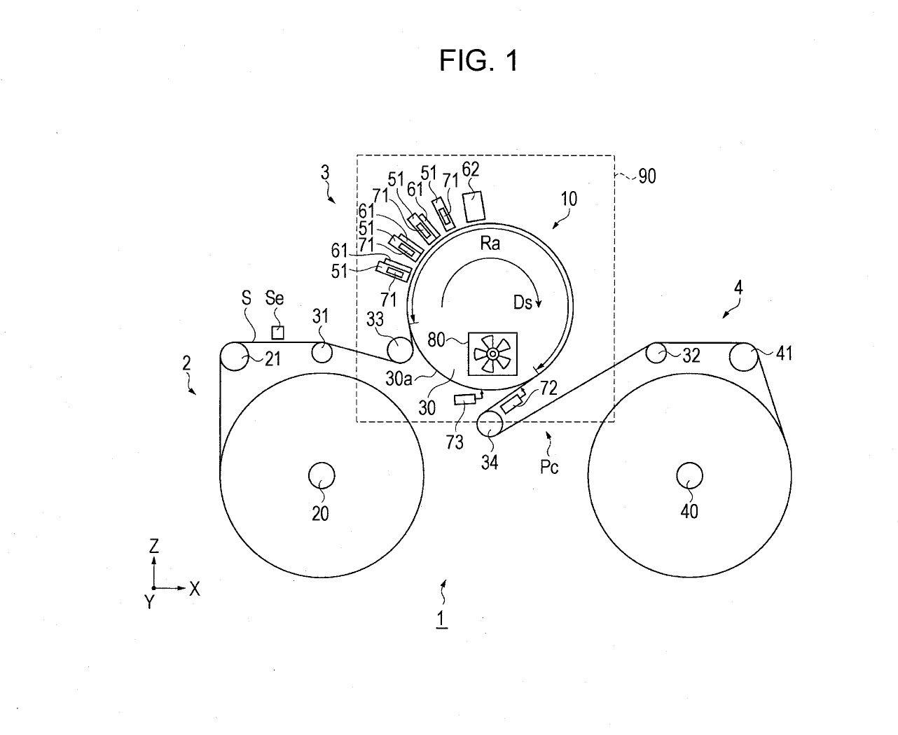

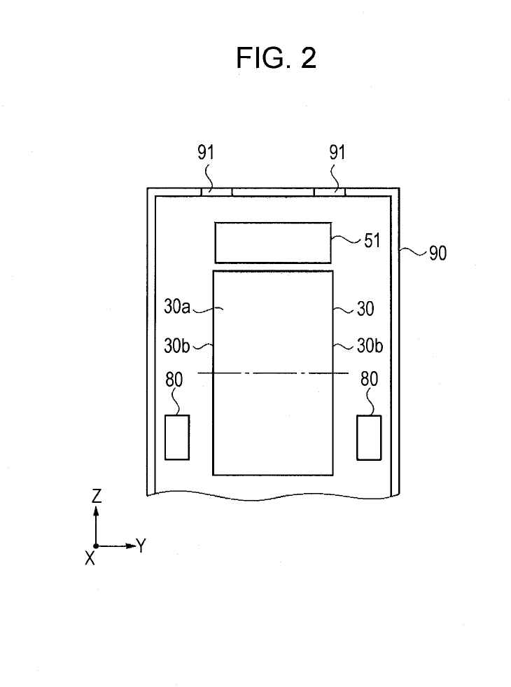

The configuration of the ink jet recording apparatus is described. FIG. 1 is a schematic view illustrating the configuration of the ink jet recording apparatus and FIG. 2 is a schematic view illustrating the partial configuration of the ink jet recording apparatus. As illustrated in FIG. 1, in the ink jet recording apparatus 1, one sheet S (web), as a work, of which both ends are wound around a feed-out shaft 20 and a wind-up shaft 40 in roll forms is stretched upon between the feed-out shaft 20 and the wind-up shaft 40. The sheet S is transported from the feed-out shaft 20 to the wind-up shaft 40 along a transportation path Pc stretched in the above manner. The ink jet recording apparatus 1 is configured to discharge the functional liquid onto the sheet S to be transported along the transportation path Pc and record (form) an image on the sheet S. It is to be noted that the sheet S is not particularly limited thereto, and paper, a film, and the like can be applied for the sheet S. For example, the paper includes high-quality paper, cast paper, art paper, and coated paper and the like, and the film includes synthetic paper, polyethylene terephthalate (PET) film, and polypropylene (PP) film and the like.

The ink jet recording apparatus 1 is constituted by a feed-out portion 2, a processor 3, and a wind-up portion 4 as a schematic configuration. The feed-out portion 2 feeds out the sheet S from the feed-out shaft 20. The processor 3 records an image on the sheet S fed out from the feed-out portion 2. The wind-up portion 4 winds up the sheet S on which the image has been recorded in the processor 3 around the wind-up shaft 40. The processor 3 includes a temperature adjusting portion 10. In the following description, in both surfaces of the sheet S, the surface on which the image is recorded is referred to as a front surface while the surface at the opposite side is referred to as a back surface in some cases.

The feed-out portion 2 includes the feed-out shaft 20 and a driven roller 21. The end of the sheet S is wound around the feed-out shaft 20. The sheet S drawn out from the feed-out shaft 20 is wound over the driven roller 21. The feed-out shaft 20 winds up and support the end of the sheet S in a state where the front surface of the sheet S faces to the outer side. If the feed-out shaft 20 rotates in the clockwise direction in FIG. 1, the sheet S wound around the feed-out shaft 20 is fed out to the processor 3 through the driven roller 21. Note that the sheet S is wound around the feed-out shaft 20 through the center core shaft (not illustrated) that is detachably attached to the feed-out shaft 20. Accordingly, when the sheet S wound around the feed-out shaft 20 has been used up, a new center core shaft around which the sheet S is wound in the roll form is attached to the feed-out shaft 20. In this manner, the sheet S around the feed-out shaft 20 can be replaced.

The processor 3 causes discharge heads 51 and the like to perform processing appropriately so as to record an image on the sheet S while supporting the sheet S fed out from the feed-out portion 2 on a platen drum 30 (supporting drum) as a supporting portion. The discharge heads 51 and the like are arranged along the outer circumferential surface (supporting surface) of the platen drum 30.

The platen drum 30 is a cylindrical drum supported by a supporting mechanism (not illustrated) in a rotatable manner. The sheet S to be transported from the feed-out portion 2 to the wind-up portion 4 is wound over the platen drum 30 from the back surface side. The platen drum 30 is drivenly rotate in the transportation direction Ds of the sheet S by receiving a frictional force between the platen drum 30 and the sheet S and supports the sheet S from the back surface side. Note that driven rollers 33 and 34 are provided on the processor 3. The driven rollers 33 and 34 fold the sheet S back at both sides of a winding portion over the platen drum 30. The driven roller 33 folds back the sheet S by winding the front surface of the sheet S over the driven roller 33 between the driven roller 21 and the platen drum 30. On the other hand, the driven roller 34 folds back the sheet S by winding the front surface of the sheet S over the driven roller 34 between the platen drum 30 and the driven roller 41. The sheet S is folded back at the upstream side and the downstream side in the transportation direction Ds with respect to the platen drum 30 in this manner so as to ensure the length of a winding portion Ra of the sheet S over the platen drum 30 to be large.

In the above manner, the sheet S to be transported is supported on the outer circumferential surface of the platen drum 30. Further, a plurality of discharge heads 51 corresponding to different colors, for example, are provided on the processor 3 for recording (forming) an image on the front surface of the sheet S supported by the platen drum 30. In the embodiment, four discharge heads 51 corresponding to yellow, cyan, magenta, and black are provided. The respective discharge heads 51 are opposed to the front surface of the sheet S wound over the platen drum 30 with slight clearances therebetween and discharge the functional liquids of corresponding colors with the ink jet system. Then, the discharge heads 51 discharge the functional liquids onto the sheet S to be transported in the transportation direction Ds so that a color image is formed on the front surface of the sheet S.

In the embodiment, ultraviolet (UV) ink (photo-curable ink) that cures by being irradiated with ultraviolet rays (light) is used as the functional liquid. UV lamps 61 (light irradiation devices) are provided on the processor 3 for curing the UV ink and fixing the UV ink onto the sheet S. It is to be noted that the UV ink is cured at two stages of provisional curing and permanent curing. The UV lamps 61 for the provisional curing are arranged at positions between the plurality of adjacent discharge heads 51. That is to say, the UV lamps 61 irradiate weak ultraviolet rays so as to cure (provisionally cure) the UV ink to the extent that the shapes of the UV ink do not collapse and does not cure the UV ink completely. On the other hand, a UV lamp 62 for permanent curing is provided at the downstream side in the transportation direction Ds with respect to the plurality of discharge heads 51. That is to say, the UV lamp 62 irradiates ultraviolet rays stronger than those irradiated by the UV lamps 61 so as to completely cure (permanently cure) the UV ink. The provisional curing and the permanent curing are executed in this manner, so that the color image formed by the plurality of discharge heads 51 can be fixed onto the front surface of the sheet S. It is to be noted that in the embodiment, a protection cover 90 is provided so as to cover the processor 3 in order to prevent the ultraviolet rays from leaking from the UV lamps 61 and 62 and the like.

As described above, the sheet S is wound over the outer circumferential surface of the platen drum 30 so as to be supported in the processor 3. Further, the respective functional parts including the discharge heads 51 and the UV lamps 61 and 62 are opposed to the winding portion Ra of the platen drum 30 over which the sheet S is wound with the sheet S interposed therebetween so as to discharge the UV ink onto the surface of the sheet S wound over on the winding portion Ra appropriately and cure the UV ink. Then, the sheet S on which the color image has been formed is transported to the wind-up portion 4.

Further, the ink jet recording apparatus 1 in the embodiment includes the temperature adjusting portion 10. The temperature adjusting portion 10 adjusts first temperatures of the UV inks to be equal to or higher than a second temperature of the sheet S and adjusts the second temperature of the sheet S supported by the platen drum 30 to be higher than a third temperature of the platen drum 30. That is to say, the processor 3 includes the temperature adjusting portion 10 in addition to the discharge heads 51 that discharge the UV inks as liquid droplets onto the sheet S supported by the platen drum 30.

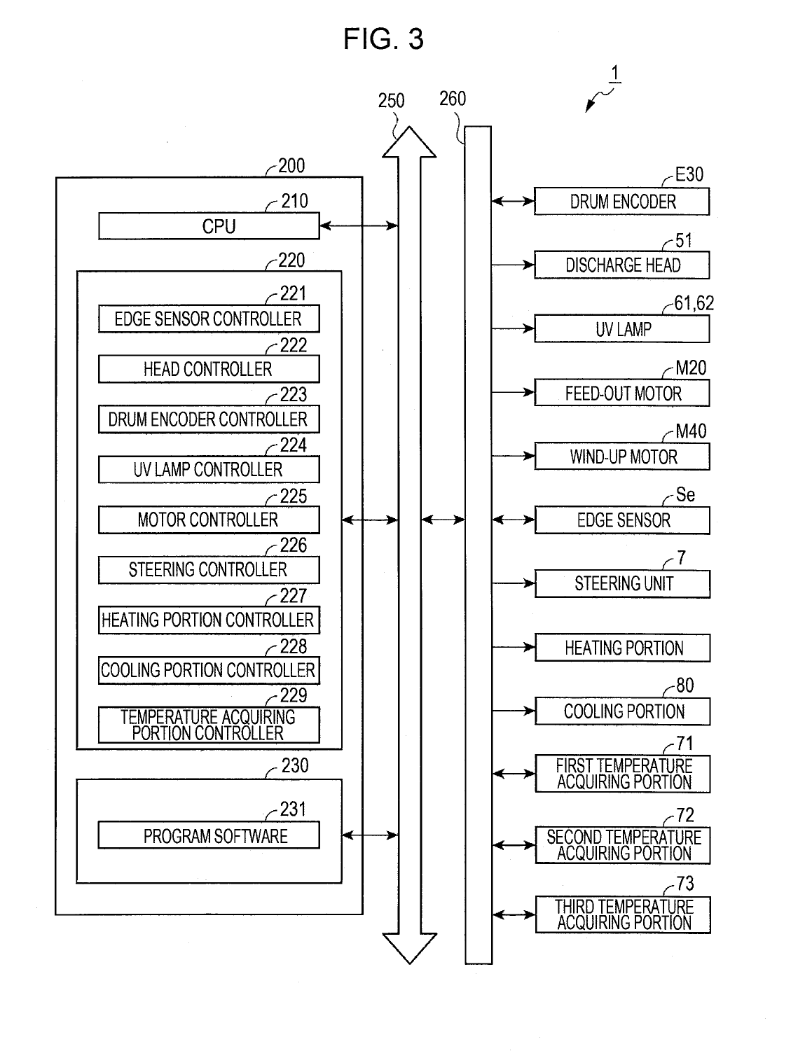

The temperature adjusting portion 10 in the embodiment includes a heating portion (not illustrated), first temperature acquiring portions 71, a second temperature acquiring portion 72, cooling portions 80, a third temperature acquiring portion 73, a controller 200 (see FIG. 3), and the like. The heating portion heats the UV inks in the discharge heads 51. The first temperature acquiring portions 71 acquire the first temperatures of the UV inks in the discharge heads 51. The second temperature acquiring portion 72 acquires the second temperature of the sheet S. The cooling portions 80 cool the platen drum 30. The third temperature acquiring portion 73 acquires the third temperature of the platen drum 30. The controller 200 controls the cooling portions 80 based on the first temperature, the second temperature, and the third temperature which have been acquired.

Various types of heating units such as a heater, a hot air system, and a hot water circulation system can be applied to the heating portion. For example, the hot water circulation systems are installed on halfway of ink supply tubes connecting ink tanks (not illustrated) and the respective discharge heads 51. The systems are driven so as to heat the UV inks flowing through the ink supply tubes. This makes it possible to keep the viscosity of the UV ink constant and ensure the discharge property of the UV ink.

The first temperatures of the UV inks are measured by the first temperature acquiring portions 71. In the embodiment, the first temperature acquiring portions 71 are installed on the predetermined surfaces of the respective discharge heads 51. The first temperature acquiring portions 71 include thermocouples, thermistors, and the like, for example. If the first temperature acquiring portions 71 are driven, the temperatures of the discharge heads 51 are acquired. Then, the first temperatures of the UV inks in the discharge heads 51 can be acquired from the acquired temperatures of the discharge heads 51.

The second temperature of the sheet S on which the image has been formed is measured by the second temperature acquiring portion 72. In the embodiment, the second temperature acquiring portion 72 is installed at the downstream side with respect to the discharge heads 51. For example, the second temperature acquiring portion 72 may be arranged at a position immediately after the sheet wound over the platen drum 30 has been separated from the supporting surface 30a supporting the sheet S on the platen drum 30. The second temperature acquiring portion 72 includes a thermocouple, a thermistor, and the like, for example. If the second temperature acquiring portion 72 is driven, the second temperature of the sheet S on which the image has been formed can be acquired.

The cooling portions 80 are cooling units such as cooling fans, for example. The cooling portions 80 are installed in the vicinity of the platen drum 30 at lower positions relative to the rotating shaft of the platen drum 30. In the embodiment, as illustrated in FIGS. 1 and 2, the cooling portions 80 are installed so as to be opposed to side surfaces 30b of the platen drum 30 other than the supporting surface 30a supporting the sheet S. If the cooling portions 80 are driven, cool air hits the platen drum 30 forcedly so as to lower the third temperature of the platen drum 30. In addition, ventilation holes 91 are opened on the upper portions of the protection cover 90. If the cooling portions 80 are driven, the air flows from the platen drum 30 side to the ventilation holes 91 side. This improves ventilation property so as to lower the temperature of the platen drum 30 efficiently.

The third temperature of the platen drum 30 is measured by the third temperature acquiring portion 73. In the embodiment, the third temperature acquiring portion 73 is installed on the supporting surface 30a of the platen drum 30. For example, the third temperature acquiring portion 73 may be installed on a region of the supporting surface 30a over which the sheet S is not wound. The third temperature acquiring portion 73 includes a thermocouple, a thermistor, and the like, for example, and is configured that if the third temperature acquiring portion 73 is driven, the third temperature of the platen drum 30 can be acquired.

In the embodiment, contact-type temperature sensors are used as the first to third temperature acquiring portions 71 to 73 but the first to third temperature acquiring portions 71 to 73 are not limited thereto. For example, radiation thermometers using thermography or the like may be used. The radiation thermometer measures a temperature in a non-contact manner so as to efficiently measure the temperature of a place, which cannot be measured directly. Further, in the embodiment, fans (air cooling systems) are used as the cooling portions 80 but the cooling portions 80 are not limited thereto. The cooling portions 80 of water cooling systems may be used. With this, the effects same as those as described above can be also obtained.

The wind-up portion 4 includes a driven roller 32 and a driven roller 41 in addition to the wind-up shaft 40 around which the end of the sheet S is wound. The sheet S is wound over the driven roller 32 and the driven roller 41 from the back surface side thereof between the wind-up shaft 40 and the driven roller 34. The wind-up shaft 40 winds up the end of the sheet S so as to support the sheet S in a state where the front surface of the sheet S faces to the outer side. That is to say, if the wind-up shaft 40 rotates in the clockwise direction in FIG. 1, the transported sheet S is wound up by the wind-up shaft 40 through the driven roller 41. Note that the sheet S is wound up by the wind-up shaft 40 through the center core shaft (not illustrated) that is detachably attached to the wind-up shaft 40. Accordingly, when the sheet S wound up by the wind-up shaft 40 reaches the upper limit amount, the sheet S can be detached together with the center core shaft.

Next, a control configuration of the ink jet recording apparatus 1 is described. FIG. 3 is a block diagram illustrating the control configuration of the ink jet recording apparatus. As illustrated in FIG. 3, the ink jet recording apparatus 1 includes the controller 200 that controls the above-mentioned constituent components. The controller 200 includes a central processing unit (CPU) 210, a driving controller 220, and a memory portion 230. The driving controller 220 and the memory portion 230 are connected to the CPU 210 through a bus 250.

The members such as the discharge head 51, the UV lamps 61 and 62, a feed-out motor M20, a wind-up motor M40, a steering unit 7, the heating portion and the cooling portion 80 are connected to the controller 200 through an input/output interface 260 and the bus 250. Further, a drum encoder E30, an edge sensor Se, and the first to third temperature acquiring portions 71, 72, and 73 are also connected to the controller 200 through the input/output interface 260 and the bus 250.

The CPU 210 as a processor performs various pieces of operation processing. The driving controller 220 controls driving of the respective members and the like. The memory portion 230 includes a random access memory (RAM), a read only memory (ROM), and the like. A region storing program software 231 in which control procedures of operations in the ink jet recording apparatus 1 are described, a data loading portion as a region loading various pieces of data temporarily, and the like are set on the memory portion 230. The data loaded on the data loading portion includes drawing data indicating a pattern to be drawn on the sheet S and program data of drawing processing and the like, for example.

The driving controller 220 includes an edge sensor controller 221, a head controller 222, a drum encoder controller 223, a UV lamp controller 224, a motor controller 225, a steering controller 226, a heating portion controller 227, a cooling portion controller 228, a temperature acquiring portion controller 229, and the like. The controller 200 performs driving control on the respective members and the like of the ink jet recording apparatus 1 based on the program software 231 read out from the memory portion 230.

The controller 200 controls ink discharge timings of the respective discharge heads 51 forming a color image in accordance with the transportation of the sheet S. To be more specific, the ink discharge timings are controlled based on output (detected value) of the drum encoder E30. The drum encoder E30 is attached to the rotating shaft of the platen drum 30 and detects a rotating position of the platen drum 30. That is to say, since the platen drum 30 is drivenly rotated with the transportation of the sheet S, the transportation position of the sheet S can be grasped by referring to the output of the drum encoder E30 that detects the rotating position of the platen drum 30. Then, the controller 200 generates a print timing signal (pts) from the output from the drum encoder E30 and controls the ink discharge timings of the respective discharge heads 51 based on the pts signal. With this, the UV inks discharged by the respective discharge heads 51 are made to land on target positions of the sheet S to be transported so as to form a color image.

Further, the controller 200 plays the function of controlling transportation of the sheet S, which has been described in detail with reference to FIG. 1. That is to say, the feed-out motor M20 and the wind-up motor M40 are connected to the feed-out shaft 20 and the wind-up shaft 40, respectively, among the members constituting the sheet transportation system. The controller 200 controls the speed and torque of each motor to control the transportation of the sheet S while rotating each of the feed-out motor M20 and the wind-up motor M40.

In this case, the controller 200 causes to feed the sheet S while adjusting the position of the sheet S to be supplied from the feed-out shaft 20 to the platen drum 30 side in the width direction (Y-axis direction) thereof. That is to say, the steering unit 7 is provided on the ink jet recording apparatus 1. The steering unit 7 displaces the feed-out shaft 20 and the driven roller 21 in the axial directions (in other words, width direction of the sheet S). Further, the edge sensor Se is arranged between the driven roller 21 and the driven roller 31. The edge sensor Se detects the end of the sheet S in the width direction. The edge sensor Se can be constituted with a distance sensor such as an ultrasonic sensor, for example. The controller 200 controls the steering unit 7 in the feedback manner based on the detection result of the edge sensor Se so as to adjust the position of the sheet S in the width direction. This optimizes the position of the sheet S in the width direction to suppress transportation failure such as winding of the sheet S.

Next, a temperature control method in the ink jet recording apparatus 1 is described. The ink jet recording apparatus according to the embodiment adjusts the first temperatures of the UV inks to be discharged to be equal to or higher than the second temperature and the second temperature of the sheet S to be higher than the third temperature of the platen drum 30. Then, the ink jet recording apparatus performs recording while adjusting the third temperature of the platen drum 30 by cooling the platen drum 30.

To be more specific, the temperatures of the respective constituent members are controlled to satisfy the above-mentioned conditions such that the first temperatures of the UV inks are in the range of 35° C. to 45° C., the second temperature of the sheet S is in the range of 25° C. to 40° C., the third temperature of the platen drum 30 is in the range of equal to or lower than 25° C.

First, when the UV ink is discharged onto the sheet S supported by the platen drum 30, the heating portion (in the embodiment, hot water circulation system) is controlled in advance. With this, the UV inks are heated and the temperatures thereof are increased. Then, the temperatures of the discharge heads 51 are increased with the increase in the temperature of the UV ink.

Subsequently, the first temperature acquiring portions 71 installed at the predetermined places of the discharge heads 51 are driven to acquire the temperatures of the discharge heads 51. The acquired temperatures of the discharge heads 51 can be substituted as the temperatures of the UV inks. Therefore, in the embodiment, the acquired temperatures of the discharge heads 51 are acquired as the first temperatures of the UV inks. Then, when the first temperatures are in the predetermined temperature range, the respective discharge heads 51 are driven so as to discharge the UV inks as liquid droplets onto the sheet S. At the same time, the UV lamps 61 and 62 are driven. With this, an image is formed on the sheet S.

Further, the second temperature acquiring portion 72 installed in a contact manner with the surface of the sheet S is driven to acquire the second temperature of the sheet S. In addition, the third temperature acquiring portion 73 installed on the surface of the platen drum 30 is driven to acquire the third temperature of the platen drum 30.

Then, the first temperatures of the UV inks are controlled to be equal to or higher than the second temperature of the sheet S and the second temperature of the sheet S is controlled to be higher than the third temperature of the platen drum 30 based on the first temperatures, the second temperature, and the third temperature which have been acquired. For example, for the first temperatures of the UV inks, the heating portion is controlled to be driven such that the first temperatures are in the predetermined temperature range. For the second temperature of the sheet S and the third temperature of the platen drum 30, the cooling portions 80 are controlled to be driven such that the second temperature is higher than the third temperature. To be more specific, the cooling portions 80 are driven when the third temperature is about to be higher than the upper limit temperature of the predetermined temperature range. If the cooling portions 80 are driven, the cool air hits the platen drum 30 to lower the third temperature of the platen drum 30.

With the embodiment as described above, the following effects can be obtained.

First, the UV inks are heated and the heated UV inks are discharged onto the sheet S. When the UV inks are applied to the sheet S, the sheet S receives radiation heat generated by heating the UV inks in the discharge heads 51, the first temperatures of the applied UV inks, the reaction heat of the UV inks, and the like. Then, the heat received by the sheet S is transferred to the platen drum 30. Note that the third temperature of the platen drum 30 is set to be lower than the second temperature of the sheet S and is controlled by driving the cooling portions 80 by the temperature adjusting portion 10. Therefore, heat is not accumulated on the platen drum 30 and the heat received by the sheet S is dissipated through the platen drum 30. This suppresses the increase in the second temperature of the sheet S, thereby forming an image with high quality on the sheet S.

It is to be noted that the invention is not limited to the above-mentioned embodiment and various changes and improvements can be added to the above-mentioned embodiment. Modifications thereof are described below.

### Modification 1

In the above-mentioned embodiment, the ink jet recording apparatus 1 including the platen drum 30 as the supporting portion of the sheet S has been described. However, the invention is not limited to the configuration. For example, an ink jet recording apparatus including a platen with a flattened surface as the supporting portion may be employed. In this case, it is sufficient that the ink jet recording apparatus includes the temperature adjusting portion 10 including the cooling portions 80 that control the temperature of the platen. The same effects as those obtained in the above-mentioned embodiment can be also obtained with the configuration.

### Modification 2

In the above-mentioned embodiment, the case of using one sheet S (web), as the work, wound in the roll form has been described. However, the invention is not limited thereto. For example, a work of single sheets paper may be used. The same effects as those obtained in the above-mentioned embodiment can be also obtained with the configuration.

The entire disclosure of Japanese Patent Application No. 2012-096329, filed Apr. 20, 2012 is expressly incorporated by reference herein.

What is claimed is:

1. An ink jet recording method in an ink jet recording apparatus including a supporting portion that supports a work, a discharge head that discharges functional liquid onto the work supported by a work supporting surface of the supporting portion, a heating portion that heats the functional liquid, and a cooling portion that cools the supporting portion, the method comprising:
heating the functional liquid by using the heating portion such that a temperature of the functional liquid in the discharge head is a first temperature, and
cooling the supporting portion by using the cooling portion,
wherein when a temperature of the work after the functional liquid discharged from the discharge head has landed onto the work is set to a second temperature and a temperature of the work supporting surface during the cooling is set to a third temperature, the first temperature is equal to or higher than the second temperature and the second temperature is higher than the third temperature.

2. The ink jet recording method according to claim 1,
wherein the supporting portion is a supporting drum having a drum shape and the work is transported while being wound over the supporting drum,
the second temperature is a temperature immediately after the work wound over the supporting drum has been separated from the supporting drum,
the third temperature is a temperature measured at a position on the supporting surface over which the work is not wound, and
the supporting drum is cooled such that the first temperature is equal to or higher than the second temperature and the second temperature is higher than the third temperature at the cooling.

3. The ink jet recording method according to claim 2,
wherein the functional liquid is photo-curable ink and a light irradiation device arranged on a transportation path of the work at the downstream side with respect to the discharge head so as to be opposed to the supporting surface is provided,
the method further including irradiating the photo-curable ink landed onto the work with light from the light irradiation device.

4. The ink jet recording method according to claim 2,
wherein the cooling portion is a cooling fan and cool air is made to hit the supporting drum at the downstream side with respect to a rotating shaft of the supporting drum at the cooling.

5. A printing apparatus comprising:
a supporting portion that supports a work;
a discharge head that discharges functional liquid onto the work supported by a work supporting surface of the supporting portion;
a heating portion that heats the functional liquid;
a cooling portion that cools the supporting portion, and
a temperature adjusting portion that adjusts a first temperature to be equal to or higher than a second temperature and adjusts the second temperature to be higher than a third temperature when a temperature of the functional liquid in the discharge head is set to the first temperature, a temperature of the work after the functional liquid discharged from the discharge head has landed onto the work is set to the second temperature, and a temperature of the work supporting surface during the cooling is set to the third temperature.

6. The printing apparatus according to claim 5, further including:
a first temperature acquiring portion that acquires the first temperature;
a second temperature acquiring portion that acquires the second temperature, and
a third temperature acquiring portion that acquires the third temperature,
wherein the second temperature acquiring portion is arranged so as to measure the temperature of the work immediately after the work wound over the supporting drum has been separated from the supporting drum,
the third temperature acquiring portion is arranged so as to measure the temperature of the supporting surface at a position on the supporting surface over which the work is not wound, and
the temperature adjusting portion controls the heating portion such that the first temperature is a predetermined temperature and controls the cooling portion such that the first temperature is equal to or higher than the second temperature and the second temperature is higher than the third temperature.
